(19) United States
(12) Patent Application Publication
(10) Pub. No.: US 2026/0212758 A1
(43) Pub. Date: Jul. 23, 2026

(54) DRIVING ACTION EVALUATION APPARATUS AND INFORMATION PROCESSING APPARATUS

(71) Applicant: Honda Motor Co., Ltd., Tokyo (JP)

(72) Inventor: Masahiro Daimon, Saitama (JP)

(21) Appl. No.: 19/443,333

(22) Filed: Jan. 8, 2026

(30) Foreign Application Priority Data
Jan. 20, 2025 (JP) 2025-007727

(51) Int. Cl. G08G 1/0967; B60K 35/29

(52) U.S. Cl. CPC G08G 1/096791; B60K 35/29

(57) ABSTRACT

A driving action evaluation apparatus provided in an own vehicle and configured to evaluate a driving action of an other-vehicle driver of an other vehicle and to permit an own-vehicle driver of the own vehicle to browse first evaluation information relating to the driving action of the own-vehicle driver evaluated by the other vehicle, includes: an in-vehicle device having processor and memory coupled to the processor. The in-vehicle device is configured to perform: acquiring other-vehicle information relating to the driving action of the other-vehicle driver; evaluating the driving action of the other-vehicle driver based on the other-vehicle information; transmitting an evaluation result to a server device as second evaluation information relating to the other-vehicle driver; receiving the first evaluation information relating to the own-vehicle driver transmitted from the server device; and controlling a timing to enable the own-vehicle driver to browse the first evaluation information.

### CROSS-REFERENCE TO RELATED APPLICATION

This application is based upon and claims the benefit of priority from Japanese Patent Application No. 2025-007727 filed on January 20, 2025, the content of which is incorporated herein by reference.

### BACKGROUND OF THE INVENTION

### Field of the Invention

The present invention relates to a driving action evaluation apparatus and an information processing apparatus that evaluate driving action of other vehicles.

### Description of the Related Art

As this type of technology, there is known a technology in which a driver or the like of another vehicle in the surrounding performs evaluation regarding driving of an automobile driver (JP7188389B2). A vehicle determined as dangerous driving by a driver or the like of another vehicle is given a negative evaluation, and a vehicle determined as safe driving is given positive evaluation. The evaluation information is transmitted as another-vehicle evaluation information from each vehicle to an information management device. Then, an analysis result of the accumulated evaluation information is provided from the information management device to the driver of each vehicle.

The evaluation of driving action is expected to greatly contribute to traffic safety. However, in the conventional technology, it cannot be said that a trouble prevention measure between the driver or the like who performed the evaluation (the driver or the like of the vehicle who transmitted the evaluation information to the information management device) and the evaluated driver (the driver to whom the analysis result is provided from the information management device) is sufficient.

### SUMMARY OF THE INVENTION

An aspect of the present invention is a driving action evaluation apparatus provided in an own vehicle and configured to evaluate a driving action of an other-vehicle driver of an other vehicle and to permit an own-vehicle driver of the own vehicle to browse first evaluation information relating to the driving action of the own-vehicle driver evaluated by the other vehicle, including: an in-vehicle device having a processor and a memory coupled to the processor. The in-vehicle device is configured to perform: acquiring other-vehicle information relating to the driving action of the other-vehicle driver; evaluating the driving action of the other-vehicle driver based on the other-vehicle information; transmitting an evaluation result to a server device as second evaluation information relating to the other-vehicle driver; receiving the first evaluation information relating to the own-vehicle driver transmitted from the server device; and controlling a timing to enable the own-vehicle driver to browse the first evaluation information.

Another aspect of the present invention is an information processing apparatus configured to communicate with the driving action evaluation apparatus, including: a communication unit configured to communicate with each of the own vehicle and the other vehicle; and a control unit having a processor and a memory coupled to the processor. The control unit is configured to perform: managing the second evaluation information and the other-vehicle driver to be evaluated in association with each other; managing the first evaluation information and the own-vehicle driver to be evaluated in association with each other; and managing the incentive information from the own-vehicle driver who has browsed the first evaluation information and the other-vehicle driver of the other vehicle which has evaluated the own-vehicle driver in association with each other.

### BRIEF DESCRIPTION OF THE DRAWINGS

The objects, features, and advantages of the present invention will become clearer from the following description of embodiments in relation to the attached drawings, in which:

FIG. 1A is a schematic diagram illustrating an example of a driving action evaluation system;

FIG. 1B is a schematic diagram illustrating an example of a vehicle equipped with an IVI system;

FIG. 2A is a block diagram illustrating a configuration of a main part of an in-vehicle device;

FIG. 2B is a block diagram illustrating a configuration of a main part of a vehicle sensor group and a vehicle interior camera;

FIG. 2C is a block diagram illustrating a configuration of a main part of an input device and an output device;

FIG. 2D is a block diagram illustrating a configuration of a main part of a server device; and

FIG. 3 is a flowchart illustrating an example of driving action evaluation processing by a program.

### DETAILED DESCRIPTION OF THE INVENTION

### Overview

A driving action evaluation apparatus according to the present invention is mounted on each of a plurality of traveling vehicles. In the following description, a vehicle may be referred to as an own vehicle to be distinguished from another vehicle. The driving action evaluation apparatus mounted on the own vehicle evaluates the driving action of the other-vehicle driver driving the other vehicle. In addition, the driving action of the own-vehicle driver driving the own vehicle is evaluated by a driving action evaluation apparatus mounted on the other vehicle.

The evaluation result by the driving action evaluation apparatus of the own vehicle is transmitted to the driving action evaluation apparatus of the other vehicle via the external device by wireless communication. On the other hand, the evaluation result by the driving action evaluation apparatus of the other vehicle is transmitted to the driving action evaluation apparatus of the own vehicle via the external device by wireless communication. The own-vehicle driver browses the evaluation result of his/her own driving action received by the driving action evaluation apparatus of the own vehicle. Here, if the evaluation result is negative, there is a concern that a trouble such as the own-vehicle driver that was evaluated tracking the other-vehicle driver that performed the evaluation may occur. Therefore, in order to avoid such a trouble, in a case where the own-vehicle driver browses a negative evaluation result, control is performed so as to delay the timing at which the evaluation result can be browsed.

In the embodiment, a driving action evaluation apparatus is exemplified as one of functions of an In-Vehicle Infotainment (IVI) system provided in a vehicle. The driving action evaluation apparatus performs driving evaluation on the other-vehicle driver based on detection information indicating a behavior or the like of the other vehicle acquired by a sensor or the like provided in the own vehicle, information indicating a driving action of the other-vehicle driver input by the own-vehicle driver or the like by voice or the like.

The information obtained by the driving action evaluation apparatus may be sent to an external device via a public communication network as the evaluation information and managed by the external device. A driving action evaluation system including such a driving action evaluation apparatus, a public communication network, and an external device will be described in more detail with reference to the drawings.

### Configuration Example of Driving Action Evaluation System

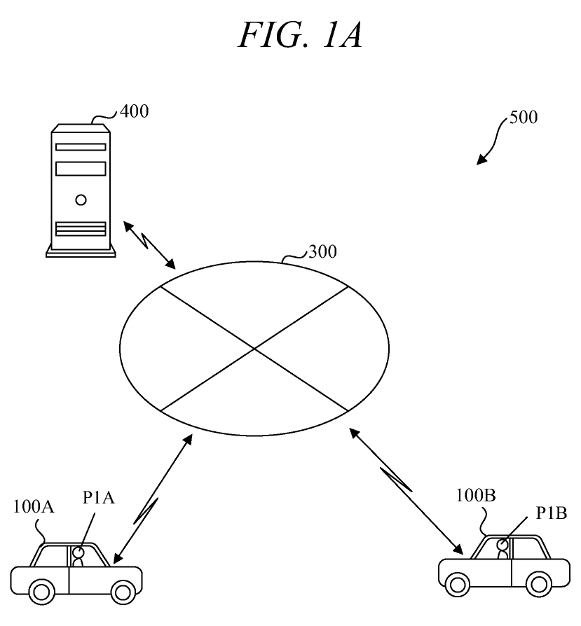

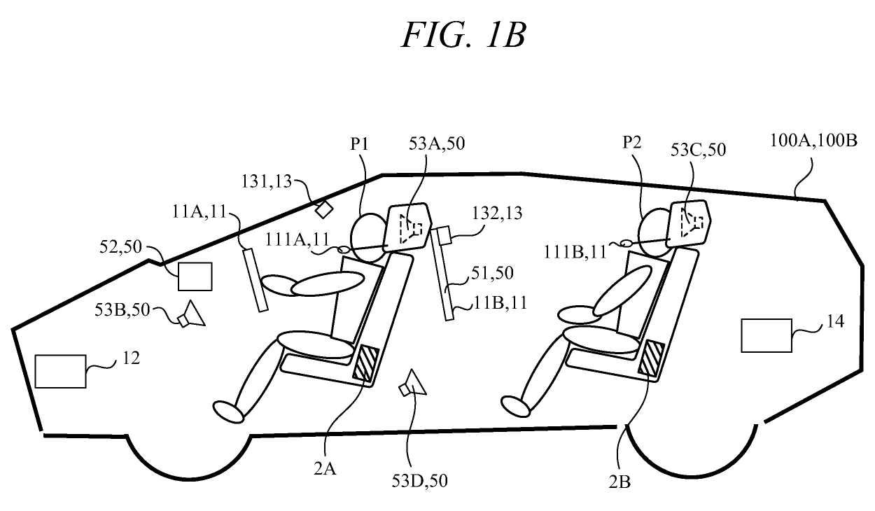

FIG. 1A is a schematic diagram illustrating an example of a driving action evaluation system 500. In the embodiment, among a plurality of vehicles, a vehicle driven by a driver P1A is referred to as a vehicle 100A, and a vehicle driven by a driver P1B is referred to as a vehicle 100B. Then, a system including the vehicle 100A, the vehicle 100B, the public communication network 300, and the server device 400 is exemplified as the driving action evaluation system 500. The vehicle 100A and the vehicle 100B evaluate driving actions of drivers of other vehicles by the driving action evaluation apparatus mounted on each of the vehicles.

Note that the vehicle 100A and the vehicle 100B have the same configuration. In the following description, in order to avoid confusion, the vehicle 100A may be referred to as an own vehicle, the driver P1A of the own vehicle may be referred to as the own-vehicle driver, the vehicle 100B may be referred to as another vehicle, and the driver P1B of the other vehicle may be referred to as the other-vehicle driver.

### Configuration In Vehicle

FIG. 1B is a schematic diagram illustrating an example of the own vehicle 100A equipped with an IVI system including a driving action evaluation function as one of the functions. A passenger P2A seated on a rear seat of the own vehicle 100A may be referred to as an own vehicle passenger, and a passenger P2B seated on a rear seat of the other vehicle 100B may be referred to as another vehicle passenger.

The IVI system includes an in-vehicle device 14, a vehicle sensor group 12, a display unit 51, a projection unit 52, and voice reproduction units 53A to 53D constituting an output device 50, operation detection units 11A and 11B and microphones 111A and 111B constituting an input device 11, a front seat camera 131 and a rear seat camera 132 constituting a vehicle interior camera 13, a terminal 2A used by the driver P1A in a front seat of the vehicle interior, and a terminal 2B used by the passenger P2A in a rear seat of the vehicle interior. FIG. 1B illustrates a case where the driver P1A and the passenger P2A are seated in the vehicle interior.

The in-vehicle device 14 and the terminals 2A and 2B are configured to be able to perform, for example, Ultra-Wide Band (UWB) wireless communication. The UWB wireless communication is a communication system that enables highly accurate positional measurement using an ultra-wide band frequency bandwidth. In the embodiment, the positions of the terminals 2A and 2B in the vehicle interior can be detected with high accuracy.

The in-vehicle device 14, the output device 50, the input device 11, the vehicle sensor group 12, and the vehicle interior camera 13 are configured to be able to perform wired communication by a Controller Area Network (CAN) or the like.

The terminals 2A and 2B are, by way of example, smartphones or the like used by each of the driver P1A and the passenger P2A. The terminals 2A and 2B may be held by a holder (not illustrated) installed on a seat on which each person sits.

Although two terminals 2A and 2B are illustrated as terminals used by the driver P1A and the passenger P2A, the actual number of terminals varies depending on the number of occupants, and may be four if there are four occupants. In addition, the number of cameras constituting the vehicle interior camera 13, the number of operation detection units and microphones constituting the input device 11, and the number of display units, projection units, and voice reproduction units constituting the output device 50 may also be appropriately changed according to the number of occupants.

In the IVI system, if a button corresponding to the driving action evaluation is touch-operated from among a plurality of menu buttons (that may be referred to as icons) displayed on the output device 50, or if a voice corresponding to the driving action evaluation is input from the microphones 111A and 111B constituting the input device 11 in a state where the output device 50 (projection unit 52, display unit 51) is caused to project or display an operation menu screen (not illustrated), the in-vehicle device 14 starts an operation as the driving action evaluation apparatus 200.

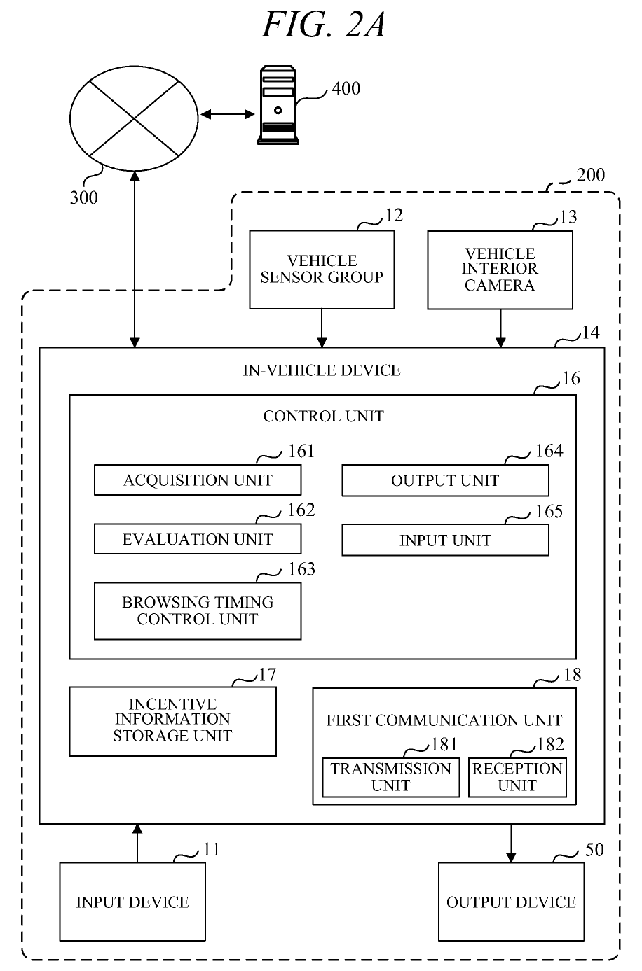

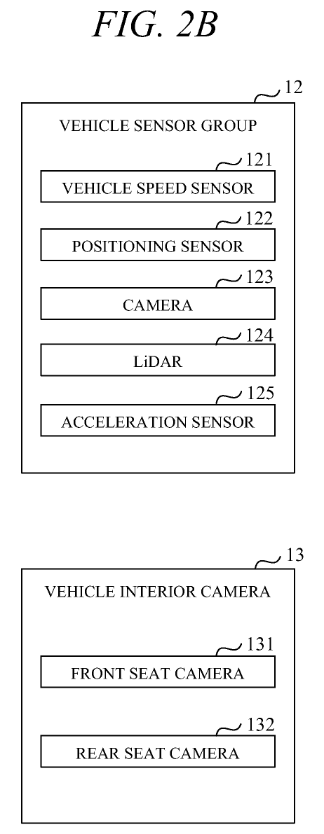

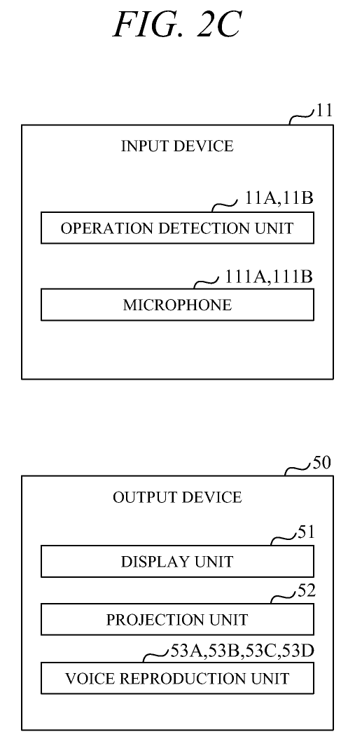

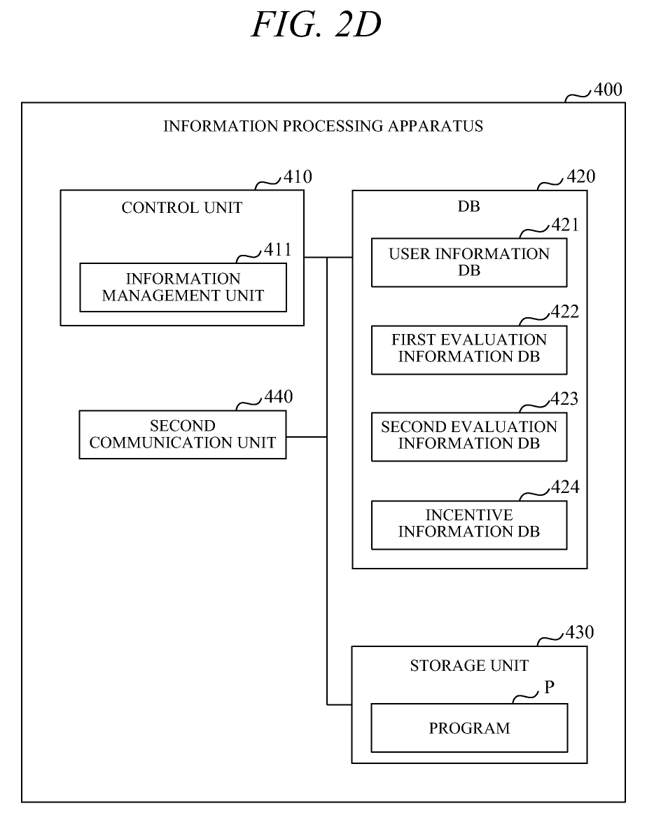

Hereinafter, the function of the in-vehicle device 14 serving as the driving action evaluation apparatus 200 will be mainly described. FIGS. 2A to 2D are diagrams describing a configuration example of each unit in FIG. 1B.

### In-vehicle Device

FIG. 2A is a block diagram illustrating a configuration of a main part of the in-vehicle device 14. The in-vehicle device 14 includes a control unit 16 that substantially functions as a Micro Processing Unit (MPU) of the IVI system, and reads and executes a predetermined program stored in a storage unit (not illustrated) in the control unit 16 to perform various information processing, control processing, and the like necessary in the in-vehicle device 14.

In FIG. 2A, the in-vehicle device 14 includes the control unit 16, an incentive information storage unit 17, and a first communication unit 18. In a case where the operation as the driving action evaluation apparatus 200 is started, the control unit 16 reads and executes an application program for the driving action evaluation apparatus 200 stored in a storage unit in the control unit 16, thereby performing various types of information processing, control processing, and the like necessary for the driving action evaluation apparatus 200.

The control unit 16 includes, as functional configurations for the driving action evaluation, an acquisition unit 161, an evaluation unit 162, a browsing timing control unit 163, an output unit 164, and an input unit 165.

### Acquisition Unit

The acquisition unit 161 acquires information regarding the driving action of the other-vehicle driver P1B of the other vehicle 100B based on the behavior of the other vehicle 100B detected by the vehicle sensor group 12 serving as the detection unit and the information input to the input unit 165 by the own-vehicle driver P1A of the own vehicle 100A.

More specifically, the acquisition unit 161 acquires, as other-vehicle information regarding the driving action of the other-vehicle driver P1B, a traveling position of the own vehicle 100A detected by a positioning sensor 122 described later, the surrounding situation of the own vehicle 100A recognized based on the camera image photographed by the camera 123 described later, the behavior of the other vehicle 100B shown in the camera image, and the behavior and reaction of the traffic participant (pedestrian etc.) in the traffic scene including the other vehicle 100B shown in the camera image.

The acquisition unit 161 may further add, to the other-vehicle information, voice information uttered by the own-vehicle driver P1A or the own vehicle passenger P2A input to the input unit 165. For example, a surprising comment, scream, or the like when the own vehicle 100A encounters the other vehicle 100B confirms that a critical situation has occurred between the own vehicle 100A and the other vehicle 100B. Furthermore, comment, murmur, and the like related to the traveling manners confirm that a situation in which the other vehicle 100B does not follow the traffic rules has occurred.

In the embodiment, as an example, when the own-vehicle driver P1A and the own vehicle passenger P2A get on the own vehicle 100A, the in-vehicle device 14 may speak to the own-vehicle driver P1A and the own vehicle passenger P2A via the voice reproduction units 53A to 53D constituting the output device 50, the microphones 111A and 111B constituting the input device 11 may collect the voice (e.g., introducing one's own name) responded by the own-vehicle driver P1A and the own vehicle passenger P2A, and the front seat camera 131 and the rear seat camera 132 constituting the vehicle interior camera 13 may photograph the own-vehicle driver P1A and the own vehicle passenger P2A.

The in-vehicle device 14 associates (may be said to relate) the faces of the own-vehicle driver P1A and the own vehicle passenger P2A, the names of the own-vehicle driver P1A and the own vehicle passenger P2A, and the frequency components of the voice uttered by the own-vehicle driver P1A and the own vehicle passenger P2A, so that it is possible to identify the faces, the names, and the voices of all the occupants in the vehicle interior.

In addition, the in-vehicle device 14 may treat a person seated on the driver's seat as the own-vehicle driver P1A, and manage first evaluation information (details will be described later) transmitted from an external device (information processing apparatus to be described later) as driving information of the own-vehicle driver P1A.

### Evaluation Unit

The evaluation unit 162 evaluates the driving action of the other-vehicle driver P1B based on the other-vehicle information acquired by the acquisition unit 161. As an example, the evaluation unit 162 scores the driving characteristics characterizing the way of driving of the other-vehicle driver P1B. This is based on the idea that the way of driving is characterized by the stability of acceleration, the stability of deceleration, the stability of turning, and the stability of straight advancement serving as driving characteristics. The score is higher the higher the stability, and the score is lower the lower the stability. Generally, a careful driving action has high stability, and a rough driving action has low stability.

In addition, the evaluation unit 162 subtracts the score based on the presence or absence of cutting in of the other vehicle 100B that requires sudden deceleration of the own vehicle 100A, the presence or absence of jumping out of the other vehicle 100B that requires sudden deceleration of the own vehicle 100A, and voice information issued by the own-vehicle driver P1A or the own vehicle passenger P2A at a timing when the own vehicle 100A encounters the other vehicle 100B. Subtraction is performed in a case where there is cutting in or jumping out, and subtraction is not performed in a case where there is no cutting in or jumping out. In addition, the point deduction range is increased in a case where there is a comment expressing surprise, a cry, a scream, or the like, and the point deduction range is suppressed in a case where there is a comment regarding traveling manners, a mutter, or the like, as compared with a case where there is the comment expressing surprise or the like.

The evaluation unit 162 sets the evaluation result calculated as described above as evaluation information (referred to as second evaluation information) with respect to the other-vehicle driver P1B.

The evaluation unit 162 recognizes the other vehicle 100B based on, for example, a number plate appearing in a camera image photographed by the camera 123, and associates (relates) the recognized vehicle number with the second evaluation information.

The second evaluation information associated with the vehicle number is transmitted to an external device (an information processing apparatus to be described later) by the transmission unit 181. It is assumed that the vehicle number is registered in the external device (information processing apparatus to be described later) in advance in association with the ID of the other-vehicle driver P1B. Therefore, the second evaluation information for each ID of the other-vehicle driver P1B is managed in association with each ID.

Thereafter, the second evaluation information associated and managed for each ID of the other-vehicle driver P1B is transmitted to the other vehicle 100B (in-vehicle device 14) associated with the ID of the other-vehicle driver P1B to be evaluated.

Note that when the second evaluation information managed by the external device (information processing apparatus to be described later) is transmitted to the in-vehicle device 14 of the other vehicle 100B associated with the ID of the other-vehicle driver P1B to be evaluated, the in-vehicle device 14 of the other vehicle 100B manages the second evaluation information as own vehicle driving information (i.e., first evaluation information) of the own-vehicle driver P1A.

### Browsing Timing Control Unit

The browsing timing control unit 163 controls the timing at which the evaluation information (first evaluation information) for the own-vehicle driver P1A that is evaluated by the driving action evaluation apparatus 200 of the other vehicle 100B and transmitted from an external device (information processing apparatus described later) can be browsed by the own-vehicle driver P1A. More specifically, in the embodiment, the timing at which the evaluation result for the driving action of the own-vehicle driver P1A can be browsed by the own-vehicle driver P1A is made different between a case where the evaluation result is higher than a predetermined reference point (may be referred to as point addition evaluation or high evaluation) and a case where the evaluation result is lower than a predetermined reference point (may be referred to as point subtraction evaluation or low evaluation). As an example, in a case where the first evaluation information is the point-addition evaluation, the timing to enable browsing is set to immediately (immediate timing) or a timing at when the first predetermined period has elapsed thereafter (after the immediate timing), and in a case where the first evaluation information is the point-subtraction evaluation, the timing to enable browsing is shifted backward until a timing at which a second predetermined period longer than the first predetermined period has elapsed.

The first predetermined period and the second predetermined period may be arbitrarily changed as a setting in advance depending on the setting on the evaluating side.

Note that the first predetermined period may be set to a short period so as to be browsed as soon as possible. The second predetermined period may be defined as follows. For example, one day is set in an area where the traffic volume is heavy based on the idea that it is difficult for the own-vehicle driver P1A to find and specify the other vehicle 100B for which the first evaluation information for the own-vehicle driver P1A has been calculated (e.g., it is difficult to specify since there are many other vehicles 100B recorded in the drive recorder). On the other hand, for example, one month is set in an area where the traffic volume is extremely small based on the idea that it is easy for the own-vehicle driver P1A to find and specify the other vehicle 100B for which the first evaluation information for the own-vehicle driver P1A has been calculated (e.g., only one another vehicle 100B recorded in the drive recorder and can be easily found). The one month period may be changed to a period equivalent to a period in which the recording of the drive recorder is overwritten and substantially disappears.

### Output Unit

The output unit 164 outputs a video signal to the output device 50 when reproducing video content serving as first evaluation information according to an instruction from the own-vehicle driver P1A. As a result, the video based on the video signal output from the output unit 164 is displayed on the display unit constituting the output device 50.

Furthermore, the output unit 164 outputs a reproduction signal to the output device 50 when reproducing sound content serving as first evaluation information according to an instruction from the own-vehicle driver P1A. As a result, the voice based on the reproduction signal output from the output unit 164 is reproduced by the speaker or the like constituting the output device 50.

Note that the first evaluation information browsed by the own-vehicle driver P1A may be content having the content praising the driving action of the own-vehicle driver P1A when the first evaluation information is the point-addition evaluation, or may be video content (moving image, still image, text display, icon display, graphic display, etc.) or sound content. The sound content may include voice content and music content.

Furthermore, the first evaluation information browsed by the own-vehicle driver P1A may be content encouraging the own-vehicle driver P1A to improve the driving action when the first evaluation information is the point-subtraction evaluation, or may be video content (moving image, still image, text display, icon display, graphic display, etc.) or sound content. The sound content may include voice content and music content.

### Input Unit

The input unit 165 inputs voices uttered by the own-vehicle driver P1A and the own vehicle passenger P2A. More specifically, a voice signal of the own-vehicle driver P1A collected by the microphone 111A is input. Furthermore, a voice signal of the own vehicle passenger P2A collected by the microphone 111B is input.

### Incentive Information Storage Unit

The incentive information storage unit 17 stores incentive information serving as content to be given to the other-vehicle driver P1B. The incentive information has a meaning of gratitude from the own-vehicle driver P1A to the other-vehicle driver P1B of the other vehicle 100B who performed the evaluation, and a plurality of types of incentive information are prepared. For example, the information may be information indicating the number of points available in another service developed by a business operator or the like who manages or operates an external device (an information processing apparatus to be described later), message information praising driving action, or short message information such as “like” or “thank you”.

In addition, the incentive information may be made different according to the score of the first evaluation information, and for example, may be divided into three stages of A, B, and C. As an example, in a case where the first evaluation information is the point-addition evaluation, the own-vehicle driver P1A who has browsed the evaluation result for the own driving action selects incentive information of an arbitrary rank from among the incentive information of rank A to rank C stored in the incentive information storage unit 17. The own-vehicle driver P1A may arbitrarily select the incentive information in a case where the driver is satisfied with the point-addition evaluation, and may not select the incentive information in a case where the driver is not satisfied with the evaluation point.

Note that instead of the own-vehicle driver P1A selecting the incentive information, the in-vehicle device 14 may be configured to automatically select incentive information of different ranks according to the score of the first evaluation information.

The selected incentive information is transmitted to an external device (an information processing apparatus to be described later) by the transmission unit 181. Thereafter, the selected incentive information is transmitted from the external device (information processing apparatus to be described later) to the other vehicle 100B (in-vehicle device 14) that performed evaluation on the own-vehicle driver P1A.

### First Communication Unit

The first communication unit 18 includes a short-range wireless communication module (not illustrated) that performs wireless communication with the terminals 2A and 2B and a wired communication module (not illustrated) that performs wired communication by CAN or the like. The UWB wireless communication system described above may be adopted for the short-range wireless communication module.

The first communication unit 18 includes a transmission unit 181 and a reception unit 182.

FIG. 2B is a block diagram illustrating a configuration of a main part of the vehicle sensor group 12 and the vehicle interior camera 13 of the own vehicle 100A.

### Vehicle Sensor Group

The vehicle sensor group 12 includes a vehicle speed sensor 121, a positioning sensor 122, a camera 123, a LiDAR 124, and an acceleration sensor 125. An operation detection sensor (not illustrated) for detecting operations on various driving operators may also be included in the vehicle sensor group 12.

### Vehicle Speed Sensor

The vehicle speed sensor 121 detects a vehicle speed of the own vehicle 100A and outputs vehicle speed information to the in-vehicle device 14.

### Positioning Sensor

The positioning sensor 122 detects the current position of the own vehicle 100A based on position measurement signals from Global Positioning System (GPS) satellites, quasi-zenith satellites, or the like. The positioning sensor 122 outputs a signal indicating the current position to the in-vehicle device 14 as position information.

### Camera

The camera 123 photographs the surroundings of the own vehicle 100A. The camera 123 outputs data of a subject image to the in-vehicle device 14 as image information. The camera 123 can capture a still image or a moving image.

### LiDAR

The Light Detection And Ranging (LiDAR) 124 performs scanning by changing an irradiation angle of laser light to be emitted, and measures detection of an object, a distance to the object, and the like based on the position information of each detection point. The measurement data is output to the in-vehicle device 14.

### Acceleration Sensor

The acceleration sensor 125 detects an acceleration of the own vehicle 100A and outputs acceleration information to the in-vehicle device 14.

### Vehicle Interior Camera

The vehicle interior camera 13 includes the front seat camera 131 and the rear seat camera 132. The front seat camera 131 photographs the upper body of the driver P1A sitting in the front seat, and outputs data of the subject image to the in-vehicle device 14 as image information. The rear seat camera 132 photographs the upper body of the passenger P2A sitting in the rear seat, and outputs data of the subject image to the in-vehicle device 14 as image information.

FIG. 2C is a block diagram illustrating a configuration of a main part of the input device 11 and the output device 50 of the in-vehicle device 14 of the own vehicle 100A.

### Input Device

The input device 11 includes operation detection units 11A and 11B and microphones 111A and 111B.

### Operation Detection Unit

The operation detection unit 11A is operated by the driver P1A in the front seat, and outputs an operation signal to the in-vehicle device 14. The operation detection unit 11A may be configured as a pointing device that interlocks with a projection image projected by the projection unit 52 described later. The operation detection unit 11B is provided on the display surface of the display unit 51. The operation detection unit 11B is operated by the passenger P2A in the rear seat and outputs an operation signal indicating a touch position to the in-vehicle device 14.

### Microphone

The microphone 111A collects voice uttered by the driver P1A in the front seat and outputs a voice signal to the in-vehicle device 14. The microphone 111B collects voice uttered by the passenger P2A in the rear seat and outputs a voice signal to the in-vehicle device 14.

### Output Device

The output device 50 includes the display unit 51, the projection unit 52, and the voice reproduction unit 53. The output device 50 is used, for example, for displaying an operation menu screen, reproducing contents, or the like.

### Display Unit

The display unit 51 has a screen such as a liquid crystal display, and displays image information based on a display signal output from the in-vehicle device 14. The image information includes the operation menu screen, an image of video content, and the like.

### Projection Unit

The projection unit 52 includes, for example, a head-up display (HUD) to be projected on a windshield or the like, and projects image information based on a projection signal output from the in-vehicle device 14. The image information includes the operation menu screen, an image of video content, and the like.

### Voice Reproduction Unit

The voice reproduction units 53A to 53D are configured as speakers for reproducing and outputting voice and the like, and reproduce sound content and the like based on a reproduction signal output from the in-vehicle device 14. Note that a voice output unit that outputs a content reproduction signal to a headphone (not illustrated) or the like may be provided.

FIG. 2D is a block diagram illustrating a configuration of a main part of a server device 400 constituting the information processing apparatus serving as an external device.

The server device 400 includes a control unit 410, database (hereinafter referred to as DB) 420, storage unit 430, and second communication unit 440. The control unit 410 includes an arithmetic processing unit such as a Central Processing Unit (CPU) or a Micro Processing Unit (MPU), and performs various types of information processing, control processing, and the like necessary for the server device 400 by reading and executing the program P stored in the storage unit 430.

The control unit 410 includes an information management unit 411 as a functional configuration.

The information management unit 411 manages the second evaluation information in association with the other-vehicle driver P1B to be evaluated, the first evaluation information in association with the own-vehicle driver P1A to be evaluated, and the incentive information from the own-vehicle driver P1A who has browsed the first evaluation information in association with the other-vehicle driver P1B of the other vehicle 100B who has evaluated the own-vehicle driver P1A as the evaluation target.

The DB 420 is a large-capacity storage device including, for example, a hard disk or the like. The DB 420 includes a user information DB 421, a first evaluation information DB 422, a second evaluation information DB 423, and an incentive information DB 424.

The user information DB 421 stores predetermined registration information regarding a user (own-vehicle driver P1A of own vehicle 100A and other-vehicle driver P1B of another vehicle 100B) registered in advance.

The first evaluation information DB 422 stores the own-vehicle driver P1A to be evaluated and the first evaluation information for the own-vehicle driver P1A.

The second evaluation information DB 423 stores the other-vehicle driver P1B to be evaluated and the second evaluation information for the other-vehicle driver P1B.

In addition, the incentive information DB 424 stores the incentive information and information indicating who gives an incentive to whom.

In the embodiment, the storage unit 430 and the DB 420 may be configured as an integrated storage device. Furthermore, the DB 420 may include a plurality of storage devices. Furthermore, the DB 420 may be an external storage device connected to the server device 400.

The storage unit 430 includes a storage element such as a Random Access Memory (RAM) or a Read Only Memory (ROM), and stores a program P, data, or the like necessary for the control unit 410 to execute processing. In addition, the storage unit 430 temporarily stores data and the like necessary for the control unit 410 to execute arithmetic processing. The storage unit 430 may further include an application storage unit (not illustrated) that stores a driving action evaluation program (Application Program; hereinafter simply referred to as an application) to be provided to the in-vehicle device 14 of the vehicle 100 for which the application is desired to be provided.

The second communication unit 440 includes a processing circuit or the like for performing processing related to communication, and transmits and receives information to and from the in-vehicle device 14 of each vehicle 100 via the public communication network 300.

### Description of Flowchart

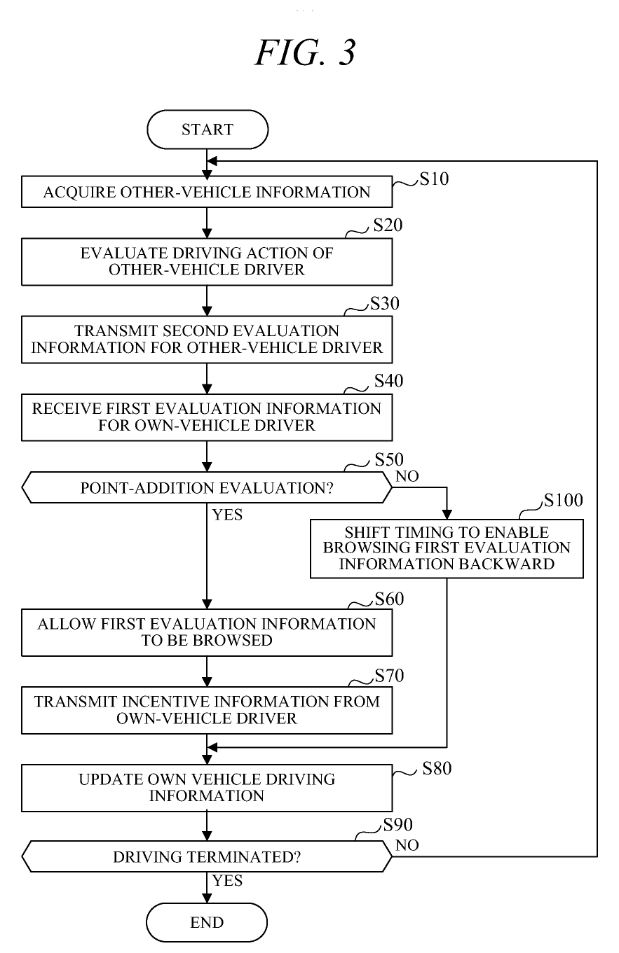

FIG. 3 is a flowchart illustrating an example of driving action evaluation processing by a program executed by the MPU (control unit 16) of the in-vehicle device 14 mounted on the own vehicle 100A. For example, when the “driving action evaluation” button is operated on the operation menu screen (not illustrated), the control unit 16 of the in-vehicle device 14 executes a program that causes the IVI system to function as the driving action evaluation apparatus 200.

In S10 (S: processing step) of FIG. 3, the control unit 16 causes the acquisition unit 161 to acquire the other-vehicle information, and proceeds to S20.

In S20, the control unit 16 causes the evaluation unit 162 to evaluate the driving action of the other-vehicle driver P1B driving the other vehicle 100B existing at the surroundings of the own vehicle 100A, and proceeds to S30. Note that the evaluation target is not limited to the other-vehicle driver P1B driving the other vehicle 100B, and for example, in a case where there is another vehicle 100C (not illustrated), the driving action of the other-vehicle driver P1C (not illustrated) driving the other vehicle 100C may be evaluated.

In S30, the control unit 16 causes the transmission unit 181 to transmit the second evaluation information for the other-vehicle driver P1B to the in-vehicle device 14 of the other vehicle 100B driven by the other-vehicle driver P1B, and proceeds to S40. In a case where the driving action of the other-vehicle driver P1C (not illustrated) is evaluated, the second evaluation information for the other-vehicle driver P1C is transmitted to the in-vehicle device 14 of the other vehicle 100C driven by the other-vehicle driver P1C.

In S40, the control unit 16 causes the reception unit 182 to receive the first evaluation information for the own-vehicle driver P1A, and proceeds to S50.

In S50, the control unit 16 determines whether or not the first evaluation information is point-addition evaluation. In a case where the first evaluation information is the point-addition evaluation, the control unit 16 makes an affirmative determination in S50 and proceeds to S60. In a case where the first evaluation information is not the point-addition evaluation, the control unit 16 makes a negative determination in S50 and proceeds to S100.

In S60, the control unit 16 allows the first evaluation information to be browsed by the browsing timing control unit 163, and proceeds to S70. As a result, the own-vehicle driver P1A can quickly browse the first evaluation information for himself/herself.

In S70, the control unit 16 causes the transmission unit 181 to transmit the incentive information from the own-vehicle driver P1A, and proceeds to S80. The transmission destination is the in-vehicle device 14 of the other vehicle 100B that performed evaluation on the own-vehicle driver P1A as an evaluation target.

In S80, the control unit 16 updates the own vehicle driving information related to the own-vehicle driver P1A, and proceeds to S90. For example, the control unit 16 records, in a storage unit (not illustrated) in the control unit 16, when and where the own-vehicle driver P1A of the own vehicle 100A traveled, what kind of driving action the own-vehicle driver P1A took, what was the rating, and the like as the own vehicle driving information. In S80, updating and recording of adding the latest driving information to such own vehicle driving information are performed.

In S90, the control unit 16 determines whether the driving is terminated. In a case where a predetermined terminating operation is performed, the control unit 16 makes an affirmative determination in S90 and terminates the processing according to FIG. 3. In a case where the terminating operation is not performed, the control unit 16 makes a negative determination in S90 and returns to S10. In the case of returning to S10, the control unit 16 repeats the above-described processing.

In step S100 to which the processing proceeds if negative determination is made in step S50 described above, the control unit 16 causes the browsing timing control unit 163 to shift the timing at which the first evaluation information can be browsed backward so as to be delayed, and then proceeds to step S80. As a result, the own-vehicle driver P1A can browse the first evaluation information for the own-vehicle driver P1A after the expiration of the second predetermined period.

According to the embodiment described above, the following effects are obtained.

(1) A driving action evaluation apparatus 200 is provided in an own vehicle 100A and evaluates a driving action of an other-vehicle driver P1B of an other vehicle 100B and permits the own-vehicle driver P1A to browse first evaluation information on the driving action of the own-vehicle driver P1A of the own vehicle 100A evaluated by the other vehicle 100B, the driving action evaluation apparatus 200 including an acquisition unit 161 that acquires other-vehicle information related to the driving action of the other-vehicle driver P1B, an evaluation unit 162 that evaluates the driving action of the other-vehicle driver P1B based on the other-vehicle information acquired by the acquisition unit 161, a transmission unit 181 that transmits an evaluation result by the evaluation unit 162 to a server device 400 serving as an external device as second evaluation information for the other-vehicle driver P1B, a reception unit 182 that receives the first evaluation information for the own-vehicle driver P1A transmitted from the server device 400, and a browsing timing control unit 163 that controls a timing at which the first evaluation information received by the reception unit 182 can be browsed by the own-vehicle driver P1A.

With this configuration, it is possible to reward the driver's effort to continuously perform the safe driving action. Then, it is expected that an increase in the number of drivers who actively take safe driving actions contributes to reduction of accidents involving vehicle 100.

In the embodiment, the driving action of the own-vehicle driver P1A who drives the own vehicle 100A is evaluated not by the driving action evaluation apparatus 200 of the own vehicle 100A but by the driving action evaluation apparatus 200 of the other vehicle 100B. If evaluation is made from the other vehicle 100B, a certain sense of tension is generated in the own-vehicle driver P1A, and an effect of further enhancing safety consciousness is expected. On the other hand, evaluating the driving action of another person may cause the own-vehicle driver P1A of the own vehicle 100A on the evaluated side to specify the other-vehicle driver P1B of the other vehicle 100B that performed the evaluation, and thus in each vehicle 100, the timing at which the evaluation information for the own-vehicle driver P1A can be browsed is controlled so that the specification becomes difficult. As a result, for example, it becomes possible for the other vehicle 100B on the evaluating side to evaluate without anxiety the driving action of the driver P1A of the own vehicle 100A on the to-be-evaluated side.

(2) In the driving action evaluation apparatus 200 of (1), the transmission unit 181 further transmits incentive information from the own-vehicle driver P1A who has browsed the first evaluation information to the server device 400.

With this configuration, it is expected that the other vehicle 100B on the evaluating side more positively evaluates the driving action of the own-vehicle driver P1A of the own vehicle 100A on the to-be-evaluated side. On the other hand, the own-vehicle driver P1A of the own vehicle 100A on the evaluated side can express a meaning of gratitude to the other-vehicle driver P1B that has performed the evaluating, for example, in a case where a satisfactory evaluation is made or in a case where the evaluation result can be sympathized or resonated. As described above, there is a merit of improving acceptability and continuous utilization of the driving action evaluation system 500 for both the evaluating side and the to-be-evaluated side.

(3) In the driving action evaluation apparatus 200 of (1), the acquisition unit 161 acquires information including at least one or more of the positions of the other vehicle 100B, the behavior of the other vehicle 100B, and the behavior and reaction of the traffic participant in the traffic scene including the other vehicle 100B as the other-vehicle information.

With this configuration, objectivity and accuracy are secured in the evaluation on the driving action, and for example, the own-vehicle driver P1A of the own vehicle 100A on the evaluated side can easily accept the evaluation result.

(4) In the driving action evaluation apparatus 200 of (1), in a case where the first evaluation information on the own-vehicle driver P1A is the point-addition evaluation, the browsing timing control unit 163 sets a timing to enable browsing to immediate timing or a timing at which a first predetermined period has elapsed thereafter, and in a case where the first evaluation information on the own-vehicle driver P1A is the point-subtraction evaluation, the timing to enable browsing is shifted backward until a timing at which a second predetermined period longer than the first predetermined period has elapsed.

With this configuration, in the case of the point-addition evaluation, it is possible to quickly notify the own-vehicle driver P1A of the point addition evaluation. On the other hand, in the case of the point-subtraction evaluation, the timing to enable browsing is delayed, thus making it difficult for the own-vehicle driver P1A on the evaluated side to specify the other-vehicle driver P1B that has performed the evaluation and avoiding occurrence of trouble. As a result, the driving action of the own-vehicle driver P1A can be safely evaluated by the other vehicle 100B driven by the other-vehicle driver P1B.

(5) The server device 400 serving as an information processing apparatus that performs communication with the driving action evaluation apparatus 200 of (2) described above includes a second communication unit 440 serving as a communication unit that performs communication with each of the own vehicle 100A and the other vehicle 100B, and an information management unit 411 that manages the second evaluation information and the other-vehicle driver P1B to be evaluated in association with each other, manages the first evaluation information and the own-vehicle driver P1A to be evaluated in association with each other, and manages the incentive information from the own-vehicle driver P1A who has browsed the first evaluation information and the other-vehicle driver P1B of the other vehicle 100B which has evaluated the browsed own-vehicle driver P1A as the evaluation target in association with each other.

With this configuration, by placing a part of the system in the server device 400 serving as an external information processing apparatus as viewed from the driving action evaluation apparatus 200 and distributing processing, it becomes possible to simplify the in-vehicle device 14 and improve software maintainability such as update and improvement of the program.

The server device 400 may be applied to an edge computer having high real-time property and data governance property in addition to a cloud type that simply performs data distribution.

In addition, the server device 400 can share information among the vehicles by accessing a plurality of vehicles 100 (100A, 100B).

The above-described embodiments may be modified into various modes. Hereinafter, modified examples will be described.

### First Modified Example

In the above-described embodiment, the case has been described in which the incentive information is sent by the own-vehicle driver P1A who received the point-addition evaluation to the other-vehicle driver P1B of the other vehicle 100B who performed the point-addition evaluation as a mean of gratitude. Instead, a business operator or the like who manages or operates the server device 400 serving as the external information processing apparatus may send the information to the own-vehicle driver P1A who performed safe driving action (in other words, who received point-addition evaluation), or the business operator or the like may send the information to the other-vehicle driver P1B of the other vehicle 100B who performed the point-addition evaluation (in other words, who made a correct evaluation on the safe driving action by the own-vehicle driver P1A). With this configuration, there is a merit of improving acceptability and continuous utilization of the driving action evaluation system 500 for both the evaluating side and the to-be-evaluated side.

### Second Modified Example

The server device 400 serving as the information processing apparatus described above is an example, and other configurations provided in the in-vehicle device 14 may also be included in the server device 400.

The above embodiment can be combined as desired with one or more of the aforesaid modifications. The modifications can also be combined with one another.

According to the present invention, it becomes possible to safely evaluate the driving action of the other vehicle.

Above, while the present invention has been described with reference to the preferred embodiments thereof, it will be understood, by those skilled in the art, that various changes and modifications may be made thereto without departing from the scope of the appended claims.

1. A driving action evaluation apparatus provided in an own vehicle and configured to evaluate a driving action of an other-vehicle driver of an other vehicle and to permit an own-vehicle driver of the own vehicle to browse first evaluation information relating to the driving action of the own-vehicle driver evaluated by the other vehicle, comprising:
an in-vehicle device having a processor and a memory coupled to the processor, wherein
the in-vehicle device is configured to perform:
acquiring other-vehicle information relating to the driving action of the other-vehicle driver;
evaluating the driving action of the other-vehicle driver based on the other-vehicle information;
transmitting an evaluation result to a server device as second evaluation information relating to the other-vehicle driver;
receiving the first evaluation information relating to the own-vehicle driver transmitted from the server device; and
controlling a timing to enable the own-vehicle driver to browse the first evaluation information.

2. The driving action evaluation apparatus according to claim 1, wherein
the in-vehicle device is configured to perform:
transmitting incentive information from the own-vehicle driver who has browsed the first evaluation information to the server device.

3. The driving action evaluation apparatus according to claim 1, wherein
the in-vehicle device is configured to perform:
acquiring information including at least one of a position of the other vehicle, a behavior of the other vehicle, and a behavior and a reaction of a traffic participant in a traffic scene including the other vehicle as the other-vehicle information.

4. The driving action evaluation apparatus according to claim 1, wherein
in a case where the first evaluation information relating to the own-vehicle driver is a point-addition evaluation, the in-vehicle device is configured to perform:
setting the timing to be an immediate timing or a timing at which a first predetermined period after the immediate timing has elapsed, and
in a case where the first evaluation information relating to the own-vehicle driver is a point-subtraction evaluation, the in-vehicle device is configured to perform:
shifting the timing backward until a timing at which a second predetermined period longer than the first predetermined period has elapsed.

5. An information processing apparatus configured to communicate with the driving action evaluation apparatus according to claim 2, comprising:
a communication unit configured to communicate with each of the own vehicle and the other vehicle; and
a control unit having a processor and a memory coupled to the processor, wherein
the control unit is configured to perform:
managing the second evaluation information and the other-vehicle driver to be evaluated in association with each other;
managing the first evaluation information and the own-vehicle driver to be evaluated in association with each other; and
managing the incentive information from the own-vehicle driver who has browsed the first evaluation information and the other-vehicle driver of the other vehicle which has evaluated the own-vehicle driver in association with each other.
